(19) United States
(12) Patent Application Publication
(10) Pub. No.: US 2010/0300436 A1
(43) Pub. Date: Dec. 2, 2010

(54) Device for locating person in emergency environment

(76) Inventor: John S. McKeown, Angola, NY (US)

Correspondence Address: JAMES C. SIMMONS, 11 FALMOUTH LANE, WILLIAMSVILLE, NY, 14221, US

(21) Appl. No.: 11/880,535

(22) Filed: Jul. 23, 2007

(51) Int. Cl. F21V 21/084; A62B 7/00

(52) U.S. Cl. 128/202.13; 362/105; 362/253

(57) ABSTRACT

A device for automatically emanating light rearwardly from a firefighter or miner or other person wearing a breathing apparatus. The device is attached to the breathing apparatus pressure regulator and in position to be next to the person's back when the breathing apparatus is donned. The device includes, in an electrical circuit, one or more light emitters, a battery, and a biased-open pressure switch for opening and closing the circuit thereby automatically turning electrical power on and off to the light emitters. A hose connects the pressure switch to the breathing apparatus to receive pressurized air from downstream of the breathing apparatus air tank shut-off valve for operating the switch to close the circuit to automatically activate the light emitters when the valve is opened. When the valve is closed, the pressure switch opens to automatically inactivate the light emitters.

The present invention relates generally to protective gear for firefighters, miners, scuba divers, military personnel, other divers, and other workers or persons in emergency or smokey or low-light confined environments and the like. More particularly, the present invention relates to devices for increasing the visibility of such persons.

There is perhaps nothing more dreaded in firefighting than a firefighter becoming missing or trapped in a burning building. He or she may not be able to respond to radio calls and may be otherwise injured or disoriented and unable to figure out how to escape. In all the smoke and darkness and with many places to search, his or her team is not sure where he or she is since he or she may not be easily visible, yet time is of the essence in this life and death struggle to save one of their own. Moreover, during normal fighting of a fire, a fireman may get hit with the high pressure water from a fire hose and injured if he or she is not easily visible to other firefighters.

The Sago mine disaster in West Virginia illustrates the criticality of lighting for identifying the locations of miners in such emergency environments. Better lighting might have helped save lives by making it easier for miners to see the other miners and provide better accountability of where all the miners were so that help may be provided more quickly and the chances of escape improved. In the Worcester warehouse fire, wherein 6 firefighters got disoriented and died, better lighting emanating from the firefighters may have also saved lives. There are numerous other instances where better lighting may have saved lives, for example, a Buffalo, N.Y., firefighter by the name of Don Herbert who was trapped and died in 1994 when a roof collapsed on him and, with better lighting, may have been found faster by fellow firefighters, and, for another example, another Buffalo firefighter by the name of Mike Seguin who in 1997 got disoriented in a house fire, became entangled in a clothes rack, and died, and, with better lighting, may have been found much quicker by fellow firefighters.

Emergency workers typically use self-contained breathing apparatus (SCBA) which typically includes a pressurized air tank which is secured to the worker's back with a harness and which supplies breathable air via a hose and a pressure regulator (to reduce the tank air pressure to a pressure suitable for breathing) to a breathing mask worn by the worker. One such SCBA is the family of AIR-PAK (trademark) SCBAs marketed by Scott Health & Safety, a unit of Tyco Fire & Security, having offices in Monroe, N.C. SCBAs are also disclosed in U.S. Pat. Nos. 3,957,044; 6,401,714; and 7,005,980, the disclosures of which are hereby incorporated herein by reference.

Scott Health & Safety also markets a PAK-ALERT SE + (trademark) alarm, which is a distress alarm system designed to help firefighters who become incapacitated and unable to call for assistance or for one to signal his or her presence. It is integrated with the air circuit of a self-contained breathing apparatus (SCBA) and is activated when the air circuit is turned on. It has a motion detector and alarm sequence which are powered independently by a battery, after the system is initially activated by opening the air circuit. A green LED flashes continuously while the system is in operating mode. It monitors the user's motion and, if it fails to detect motion for a specified period, it will begin audible signals as well as a flashing red LED. The system is attached to the harness of the SCBA (and an air line from the pressure regulator extends thereto for supplying air pressure thereto) so as to position the system forwardly of the user so that it is visible to the user's front. Also, Scott Health & Safety also markets a PAK-TRACKER (trademark) firefighter locator system which utilizes a transmitter integrated into a firefighter's SCBA and a hand-held receiver for picking up the transmitter's signals for determining the firefighter's location.

The aforesaid U.S. Pat. No. 7,005,980 also discloses a personal alert safety system (PASS) attached to the body harness of a self-contained breathing apparatus to be positioned on the front of a firefighter to send alarms (audio and visual light) when the firefighter stops motion or gets low on air supply.

The above and similar PAK-ALERT SE + alarm and PASS are provided to be worn on the user's front so as to be visible to the user's front. Furthermore, these devices only provide light when the firefighter stops moving or gets low on air supply. These as well as other lights emanating from a firefighter's front unfortunately do not provide easy visibility from the rear of the worker of his or her location, for example, when the workers are walking single-file. Moreover, if a firefighter were down and lying on his or her stomach, the light emanating from his or her front may not be easily visible. Thus, these lights do not in some circumstances allow the determinations of the locations of other workers who are active, as when workers are walking single-file or otherwise. When walking single file, firefighters thus have difficulty seeing the person ahead and thus currently compensate by the use a line to stay in back of the person ahead.

Fireman's helmets have been provided which have rear as well as front lights, such as illustrated in U.S. Pat. Nos. 4,945,458 and 5,329,637, which are also incorporated herein by reference. However, firemen's helmets may become displaced from the fireman's head, especially in emergency situations. For example, if trapped at a window, firefighters are taught to toss their helmets out the window to alert others. Thus, the helmets are not reliable for use in providing visible indications to the rear of a firefighter of his or her position. These lights as well as other lights worn by firefighters are normally white lights provided by light bulbs.

Reflective tape has been provided on a worker's back, but the tape requires that a flashlight be used to reflect off of it for seeing the worker.

U.S. Pat. No. 6,144,302, which is also incorporated herein by reference, discloses a breathing apparatus which is donned by a fireman or other emergency worker by shoulder straps and which includes multiple battery-operated LED or laser light sources on the air tank of the breathing apparatus. The multiple laser light beams are mutually diverging, and it is claimed that the worker's location in an emergency environment is readily established as the locus of the diverging beams. The electrical circuit for powering the light sources includes a battery and a manually operated switch.

The aforesaid U.S. Pat. No. 6,144,302 states that it is desirable that the light beams be “of a color which does not excessively interfere with dark adaptation of the eye; red in the range of 670 to 630 nm is preferred for this reason,” and further states that, in an underwater context, blue-green or yellow-green light in the range of 500 to 575 nm, generated by frequency-doubling lasers, might be more visible than red or white.

In a firefighting context, red or orange or yellow or white light may undesirably give the impression of fire.

Other patents/published applications which may be of interest and which are all hereby incorporated herein by reference include U.S. Pat. Nos. 2,070,818; 2,504,381; 3,638,258 (discloses a rescue light attached to a life vest); 4,090,185; 4,570,204; 5,249,106; 5,339,764; 5,847,651; 6,257,750 (discloses an illuminating fire hose wherein LEDs are attached thereto to act as a visible marker in a darkened and/or smoke-filled enclosure); and 2006/0250815.

Laser beams travel so far that it may be difficult to trace them to the person to be located. As a number of persons are put into an emergency situation with rays from the multiple lasers of the aforesaid U.S. Pat. No. 6,144,302 emanating, each over a long distance, from all of them, the multiple lights may create so much confusion that they would be ineffectual in locating the whereabouts of the various persons.

It is accordingly an object of the present invention to effectively and reliably utilize lights to locate persons in an emergency environment.

It is another object of the present invention to automatically turn the lights on when needed and off when not needed so that battery energy is saved, without the workers having to think about it.

In order to effectively and reliably utilize lights to locate persons in an emergency environment, in accordance with the present invention, a light emanating device is connected to breathing apparatus worn by the person in a manner to emanate light from the person's back in a direction rearwardly of the person as the person is wearing the breathing apparatus.

In order to automatically turn the lights on when needed and off when not needed so that battery energy is saved, without the workers having to think about it, in accordance with the present invention, a pressure switch is provided for turning the lights on and off, the switch being activated to close the light circuit by pressurized air downstream of a valve for the release of air from the air tank.

The above and other objects, features, and advantages of the present invention will be apparent in the following detailed description of the preferred embodiment(s) thereof when read in conjunction with the accompanying drawings wherein the same reference numerals denote the same or similar parts throughout the several views.

### BRIEF DESCRIPTION OF THE DRAWINGS

FIG. 1 is an upper front view of an emergency worker wearing a self-contained breathing apparatus.

FIG. 2 is an upper rear view of the worker and illustrating a device which incorporates the present invention attached to the self-contained breathing apparatus.

FIG. 3 is a schematic view of the device attached to the self-contained breathing apparatus.

FIG. 4 is a perspective view of the device.

FIG. 5 is a circuit diagram for the device.

### DETAILED DESCRIPTION OF THE PREFERRED EMBODIMENT(S)

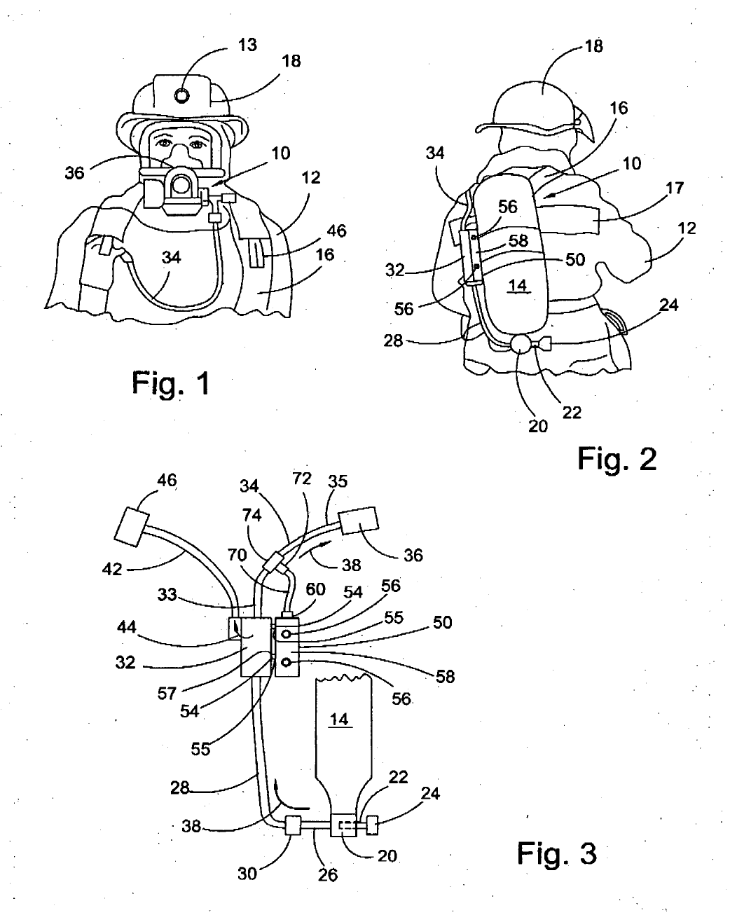

Referring to FIGS. 1 to 3, there is illustrated generally at 10 breathing apparatus donned by a person 12 who may, for example, be a firefighter, miner, diver, or other person working in confined darkened spaces or otherwise difficult to see spaces or the like. The person 12 is shown to be wearing a helmet 18, which may have a conventional light 13 on its front emanating light to the front of the person 12. The breathing apparatus 10 is shown to be of the type commonly referred to as self-contained breathing apparatus (SCBR) such as disclosed in the aforesaid U.S. Pat. Nos. 3,957,044; 6,401,714; and 7,005,980, but other suitable breathing apparatus is intended to be covered by the present invention.

Breathing apparatus 10 includes a conventional removable and replaceable air tank 14 for containing pressurized air, the term “air” being defined, for the purposes of this specification and the claims, to include any fluid suitable for breathing. The air tank 14 is secured to the body of the person 12 by a suitable harness 16. Typically, the air tank 14 is secured so as to be vertically disposed along the person's back, as illustrated in FIG. 1. At 17 is a reflective stripe, which of course is optional (it may just be part of the uniform) and constitutes no part of the present invention, across the back of the person's coat. The lower end opening of the air tank 14 is fitted with a valve 20 having a valve stem 22 and a handle 24 for opening and closing the valve 20 for releasing air from the tank 14 and ceasing the release of air therefrom respectively. The released air passes through a nipple 26 fitted to the valve 20. One end of an air hose 28 is attached to the terminal end of the nipple 26 by a nut 30 or other suitable means. The other end of the hose 28 is suitably attached to a conventional air pressure regulator 32 wherein the air pressure is reduced to a pressure suitable for breathing. The regulator 32 is typically positioned to lie alongside the air tank 14, as illustrated in FIG. 1, or otherwise next to be back of the person 12 and suitably secured. One end of another air hose 34 is suitably attached to the downstream side of the pressure regulator 32. The air hose 34 passes over a shoulder of the person 12, and its other end is suitably attached to a conventional face mask 36 which is attachable to the person's face for receiving the air for breathing thereof. The air thus flows in the direction illustrated by arrows 38, and the flow of air through the nipple 26 and through each of the hoses 28 and 34 and regulator 32 is defined as being downstream of the valve 20. The combination of hoses 28 and 34 may together be alternatively referred to herein and in the claims as a hose (singular). A fitting 40 is attached to the regulator 32 to receive the air pressure (either before or after it is reduced) into one end of hose 42, as illustrated at 44. The hose 42 is passed over a shoulder of the person 12, and its other end is attached to an audio and visual (lights) alarm 46, such as the previously discussed PAK-ALERT SE + (trademark) alarm, which may, for example, provide warning lights (again emanates light forwardly of the person 12) and sounds when there has been no movement of the person 12 for a period of time such as, for example, 30 seconds. As previously discussed, this alarm 46 is activated by pressure through hose 42 when the air circuit is turned on (i.e., valve 20 is opened). It has a motion detector and alarm sequence which are powered independently by a battery, after the system is initially activated by the air pressure in hose 42 resulting from opening the air circuit by opening valve 20. The self-contained breathing apparatus 10 and alarm 46 as so far discussed in this Detailed Description of the Preferred Embodiment(s) are conventional in the art and will therefore not be discussed in greater detail herein, and it is to be understood that the present invention may be incorporated as part of other breathing apparatus which are intended to come within the scope of the present invention.

As previously discussed, it is important to be able to see the worker 12 from behind as well as from the front. In order to be able to see the worker from behind, a light emitter device 50 is provided to be positioned on the person's back to emanate light rearwardly of the person 12. The device 50 has a housing 52 which is preferably secured to the pressure regulator 32 such as by screws or other suitable fasteners, illustrated at 54, suitably received (threadedly or otherwise) in apertures, illustrated at 55 and 57, in the device 50 and the regulator 32 respectively, so that the device 50 remains on/connected to the breathing apparatus 10 so that it is not misplaced and so that the device 50 is disposed along the person's back, as illustrated in FIG. 1, to emanate light in a direction rearwardly of the person 12 as the person 12 is wearing the breathing apparatus 10.

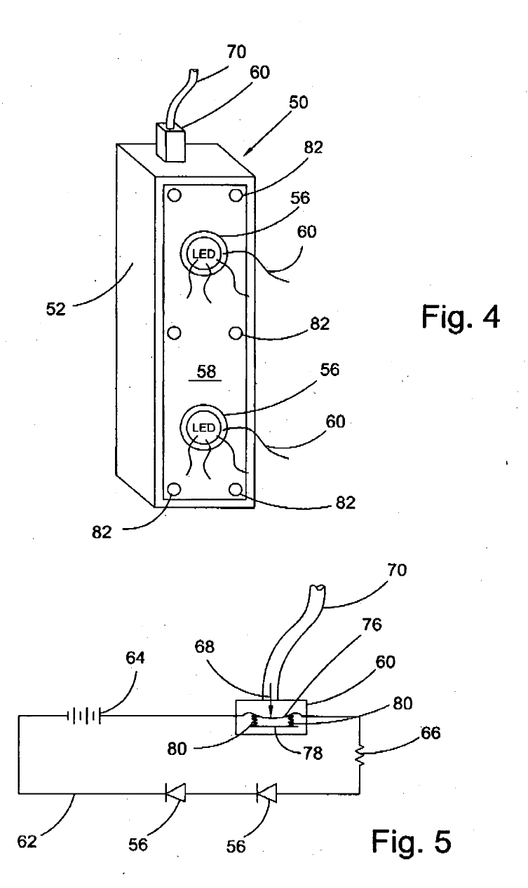

The device 50 preferably has a pair (or more) of light emitters 56. These light emitters 56 are preferably vertically spaced (for example, spaced 6 inches apart) and suitable fitted in a rear wall 58 (i.e., which faces rearwardly of the person 12 when normally donned with the breathing apparatus) to thereby emanate light rearwardly, as illustrated at 60 in FIG. 4. However, the device 50 may have any suitable number of light emitters 56.

Referring to FIGS. 4 and 5, in order to automatically activate or turn on the lights 56 when needed and inactivate or turn off the lights 56 when not needed so that battery energy is conserved, without the worker 12 having to take any additional steps or action or otherwise think about it, in accordance with the present invention, a pressure switch 60 is provided for automatically turning the lights 56 on and off, the switch 60 being automatically activated to close the light electrical circuit 62 by pressurized air downstream of the air tank shut-off valve 20. The electrical circuit 62 includes a suitable direct current battery and resistor, illustrated at 64 and 66 respectively, as well as the pressure switch 60 and lights 56, all connected in series, but may be otherwise suitably connected or have another suitable power source.

The pressure switch 60 receives pressure, as illustrated at 68, through hose 70 which is connected into hose 34 by its connection to one leg 72 of a T-coupling 74 splicing two portions 33 and 35 of hose 34 together. The combination of hose 28 and hose portions 33 and 35 may together be alternatively referred to herein and in the claims as a hose (singular). However, it should be understood that the hose 70 can be connected to the air stream from the air tank 14 anywhere suitably downstream of the valve 20. For example, the hose 70 may be suitably connected to hose 28 or to nipple 26. Pressure 68 in hose 70, when the valve 20 is open and the tank 14 is under a suitable amount of air pressure, will force the contacts 76 and 78 to engage and close the circuit 62 thereby causing the lights 56 to emit light 60. The pressure switch 60 is biased-open. Thus, one or more suitable springs 80 are suitably positioned and biased to disengage the contacts 76 and 78, as shown in FIG. 5, and thereby open the circuit 62 and automatically inactivate the light emitters 56, i.e., turn off the lights 56, when the valve 20 is closed or the pressure 68 otherwise reduced sufficiently.

As used herein and in the claims, the term “automatically” refers to no additional action being required for activation or inactivation of the light emitters when the breathing apparatus is activated or inactivated respectively.

The interior of the device 50 may be accessed, for replacement of the battery 64 or other purposes, by removal of the rear wall 58, which is attached by screws 82 or other suitable means. The battery 64 may, for example, be a 9 volt battery, which is common to other batteries, which are typically 9 volt batteries, in the typical SCBA 10.

In accordance with a preferred embodiment of the present invention, the light emitters 56 are light-emitting diodes (LEDs), which are considered to be long-lasting and consume low energy, so that the battery 64 as well as the light emitters 56 may desirably not require frequent replacement. Moreover, one can easily detect the location (worker's back) of the source of light from LEDs, as compared to laser beams which may undesirably become confusing as to their sources and otherwise. However, it should be understood that other types of light emitters, such as light bulbs or lasers, may if desired be used.

In a firefighting context, red or orange or yellow or white light may undesirably give the impression of fire, i.e., they have an appearance (color) with may be too close to that of fire. In order to reduce the chances that the light from the LEDs may be confused with fire, the LEDs 56 are preferably blue LEDs, i.e., they emit blue light, which may also be more appealing to the eye in a fire environment and which is believed to penetrate fog and smoke well in a burning building or otherwise.

With the shut-off valve 20 closed so that there is no pressure downstream thereof when the breathing apparatus 10 is not in use, the lights 56 are automatically not on since the springs 80 keep the circuit 62 open, thereby saving battery life. When the valve 20 is opened to provide pressure downstream of the valve for use of the apparatus 10, the pressure switch 60 automatically closes the circuit 62 so that the lights 56 come on automatically so that they are not mistakenly left off. The emergency worker 12 thus needs to do nothing additionally as he or she dons and begins using the breathing apparatus 10 to activate as well as to inactivate the lights 56. When a worker begins use of the breathing apparatus 10 after becoming harnessed, he or she normally conducts a self-test of the equipment, and the self-test should include checking the condition of the lights 56. Workers behind a worker should also be able to tell if one or more of the lights 56 are not working.

As apparent from the drawings, what is provided is a light emitter device which is small, lightweight, low maintenance, and can easily be incorporated into firefighting and other emergency worker gear, yet it serves a critical and long-felt need of providing greater visibility of workers in emergency environments so that, when down, they can be located more easily, and their locations can otherwise be detected more easily.

It should be understood that, while the present invention has been described in detail herein, the invention can be embodied otherwise without departing from the principles thereof, and such other embodiments are meant to come within the scope of the present invention as defined by the appended claims.

What is claimed is:

1. A lighting device for use with a breathing apparatus, the device comprising a housing, means for attaching said housing to the breathing apparatus in a manner to be positioned to emanate light rearwardly of a person when the person has donned and activated the breathing apparatus for breathing, an electrical circuit at least partially in said housing, said circuit including at least one light emitter for emanating light from said housing, a power source for activating said at least one light emitter, and a biased-open pressure-activated switch, and the device further comprising means for routing pressurized air from downstream of an air tank shut-off valve for activating the breathing apparatus to said pressure switch for closing said pressure switch for automatically activating said at least one light emitter when the breathing apparatus is activated.

2. A device according to claim 1 wherein said at least one light emitter is a light emitting diode.

3. A device according to claim 1 wherein said at least one light emitter is of a type that emits blue light.

4. A device according to claim 1 wherein said at least one light emitter is a blue light emitting diode.

5. A device according to claim 1 wherein said at least one light emitter is a pair of light emitters spaced about 6 inches apart.

6. In combination with a breathing apparatus to be worn by a person and including at least one air tank, a harness, a face mask, hose connecting said air tank to said face mask for supplying pressurized air from said air tank to said face mask for breathing thereof by the person, and a valve for shutting off pressurized air supply from said air tank, a device connected to said breathing apparatus in a manner to emanate light from the person's back in a direction rearwardly of the person as the person is wearing said breathing apparatus, said light emanating device including at least one light emitter, an electrical circuit including a power source for supplying power for said at least one light emitter and including a pressure switch for opening and closing said circuit thereby turning electrical power on and off to said at least one light emitter, and a hose connecting said pressure switch to said breathing apparatus in a manner to receive pressurized air from downstream of said valve for operating said switch to close said circuit when said valve is opened to supply pressurized air to said face mask for breathing by the person.

7. A combination according to claim 6 wherein said at least one light emitter is a light emitting diode.

8. A combination according to claim 6 wherein said at least one light emitter is of a type that emits blue light.

9. A combination according to claim 6 wherein said at least one light emitter is a blue light emitting diode.

10. A combination according to claim 6 wherein said breathing apparatus further includes a pressure regulator, and said device is attached to said pressure regulator.

11. A combination according to claim 6 wherein said hose connecting said pressure switch to said breathing apparatus is connected to said hose connecting said air tank to said face mask downstream of said pressure regulator.

12. A combination according to claim 6 wherein said breathing apparatus is a self-contained breathing apparatus.

13. A combination according to claim 6 wherein said at least one light emitter is a pair of light emitters oriented to be spaced vertically when said breathing apparatus is donned.

14. A method of increasing visibility of a person rearwardly thereof while the person is wearing and utilizing a breathing apparatus, the method comprising the steps of:
(a) securing to the breathing apparatus a device having at least one light emitter;
(b) positioning the device to emanate light from the person's back in a direction rearwardly of the person as the person is wearing and utilizing the breathing apparatus; and
(c) connecting the device to the breathing apparatus in a manner to automatically activate the at least one light emitter to effect emanation of light therefrom when the breathing apparatus is activated for breathing and to automatically inactivate the at least one light emitter when the breathing apparatus is inactivated.

15. A method according to claim 14 wherein the step of automatically activating comprises routing pressurized air from the breathing apparatus to a biased-open switch in an electrical circuit for the at least one light emitter to close the switch to automatically activate the at least one light emitter, whereby the biased-open switch opens when pressurized air from the breathing apparatus is shut off to open the circuit to automatically inactivate the at least one light emitter.

16. A method according to claim 14 wherein the step of securing the device comprises attaching the device to a pressure regulator for the breathing apparatus.

17. A method according to claim 15 wherein the step of securing the device comprises attaching the device to a pressure regulator for the breathing apparatus.

18. A method according to claim 17 wherein the step of routing pressurized air comprises routing compressed air from downstream of the pressure regulator.

19. A method according to claim 14 further comprising donning and activating the breathing apparatus with the lighting device positioned along the person's back and activating the breathing apparatus thereby automatically activating the at least one light emitter to emanate light rearwardly from the person's back.
